(19) United States
(12) Patent Application Publication
(10) Pub. No.: US 2019/0050934 A1
(43) Pub. Date: Feb. 14, 2019

(54) SYSTEM AND METHOD FOR FULFILLING PURCHASE ORDERS

(71) Applicants: David Beech, Katy, TX (US); Charles Q. Beech, III, Katy, TX (US)

(72) Inventors: David Beech, Katy, TX (US); Charles Q. Beech, III, Katy, TX (US)

(21) Appl. No.: 16/059,030

(22) Filed: Aug. 8, 2018

Related U.S. Application Data
(60) Provisional application No. 62/542,765, filed on Aug. 8, 2017.

(51) Int. Cl. G06Q 30/06; G06Q 50/28

(52) U.S. Cl. CPC G06Q 30/0635; H04L 67/42; G06Q 50/28; G06Q 30/0611

(57) ABSTRACT

This is a distributed computing solution that allows a procurement agent to process, manage and fulfill purchase orders for one or more distribution clients. The system can analyze and track the fulfillment of all orders to ensure that the most efficient supplier is utilized. Furthermore, the system tracks the progress of the orders to ensure that the orders are fulfilled on time or that the appropriate extensions are obtained from the distribution clients, if necessary.

### CROSS REFERENCE TO RELATED APPLICATIONS

The present application is a U.S. Non-Provisional patent application that claims priority to U.S. Provisional Patent Application Ser. No. 62/542,765, entitled “System and Method for Fulfilling Purchase Orders” filed on Aug. 8, 2017, which is incorporated in its entirety by reference.

### REFERENCE TO GOVERNMENT FUNDING SOURCES

Not applicable.

### REFERENCE TO SEQUENCE LISTING

Not applicable.

### FIELDS OF THE INVENTION

The disclosure as detailed herein is in the technical field of fulfilling purchase order requests from a distribution client.

### DESCRIPTION OF RELATED ART

There are many difficulties which arise in the management and fulfillment of purchase orders. Namely the efficient tracking of past orders and supplier information as well as the efficient fulfillment of new orders utilizing past suppliers. The invention solves these problems by creating a platform whereby the user can efficiently track, manage and analyze all past orders and the system then analyses those past orders to add in the selection of the suppliers to fulfill the current orders. The system also tracks the fulfillment of each order and ensures that the order is either delivered on time or that the appropriate extension is obtained.

### GENERAL SUMMARY OF THE INVENTION

This is a distributed computing solution that allows a procurement agent to process, manage and fulfill purchase orders for one or more distribution clients. The system can analyze and track the fulfillment of all orders to ensure that the most efficient supplier is utilized. Furthermore, the system tracks the progress of the orders to ensure that the orders are fulfilled on time or that the appropriate extensions are obtained from the distribution clients if necessary.

### DESCRIPTION OF FIGURES

FIG. 1 is a diagram view which shows an exemplary hardware architecture of a computing device used in an embodiment of the invention.

FIG. 2 is a diagram view which shows an exemplary logical architecture for a client device, according to an embodiment of the invention.

FIG. 3 is a diagram of an exemplary architectural arrangement of clients, servers, and external services, according to an embodiment of the invention.

FIG. 4 is a diagram view which shows an embodiment of a hardware architecture of a computing device used in various embodiments of the invention.

FIG. 5 is a perspective view, which shows the Overall Use of the System.

FIG. 6 is a perspective view, which shows the System Data.

FIG. 7 is a perspective view, which shows the Procurement Interface.

FIG. 8 is a diagram of finalizing the distribution client purchase order.

FIG. 9 is a diagram of the Overall Use of the System.

FIG. 10 is a diagram of using the system as a Procurement Manager.

FIG. 11 is a diagram of using the system as a logistics analyst.

FIG. 12 is a diagram of using the system as an IT manager.

FIG. 13 is a diagram of interacting with a supplier.

FIG. 14 is a diagram of inputting a client request for quote.

FIG. 15 is a diagram of the system generating a letter to send to one or more supplier.

FIG. 16 is a diagram of the procurement manager sending out an Order.

### DETAILED DESCRIPTION

One or more different inventions may be described in the present application. Further, for one or more of the inventions described herein, numerous alternative embodiments may be described; it should be appreciated that these are presented for illustrative purposes only and are not limiting of the inventions contained herein or the claims presented herein in any way. One or more of the inventions may be widely applicable to numerous embodiments, as may be readily apparent from the disclosure. In general, embodiments are described in sufficient detail to enable those skilled in the art to practice one or more of the inventions, and it should be appreciated that other embodiments may be utilized and that structural, logical, software, electrical and other changes may be made without departing from the scope of the inventions. Accordingly, one skilled in the art will recognize that one or more of the inventions may be practiced with various modifications and alterations. Particular features of one or more of the inventions described herein may be described with reference to one or more particular embodiments or figures that form a part of the present disclosure, and in which are shown, by way of illustration, specific embodiments of one or more of the inventions. It should be appreciated, however, that such features are not limited to usage in the one or more particular embodiments or figures with reference to which they are described. The present disclosure is neither a literal description of all embodiments of one or more of the inventions nor a listing of features of one or more of the inventions that must be present in all embodiments.

Headings of sections provided in this patent application and the title of this patent application are for convenience only, and are not to be taken as limiting the disclosure in any way. Devices that are in communication with each other need not be in continuous communication with each other, unless expressly specified otherwise. In addition, devices that are in communication with each other may communicate directly or indirectly through one or more communication means or intermediaries, logical or physical.

A description of an embodiment with several components in communication with each other does not imply that all such components are required. To the contrary, a variety of optional components may be described to illustrate a wide variety of possible embodiments of one or more of the inventions and to more fully illustrate one or more aspects of the inventions. Similarly, although process steps, method steps, algorithms or the like may be described in a sequential order, such processes, methods and algorithms may generally be configured to work in alternate orders, unless specifically stated to the contrary. In other words, any sequence or order of steps that may be described in this patent application does not, in and of itself, indicate a requirement that the steps be performed in that order. The steps of described processes may be performed in any order practical. Further, some steps may be performed simultaneously despite being described or implied as occurring non-simultaneously (e.g., because one step is described after the other step). Moreover, the illustration of a process by its depiction in a drawing does not imply that the illustrated process is exclusive of other variations and modifications thereto, does not imply that the illustrated process or any of its steps are necessary to one or more of the invention(s), and does not imply that the illustrated process is preferred. Also, steps are generally described once per embodiment, but this does not mean they must occur once, or that they may only occur once each time a process, method, or algorithm is carried out or executed. Some steps may be omitted in some embodiments or some occurrences, or some steps may be executed more than once in each embodiment or occurrence.

When a single device or article is described herein, it will be clear that more than one device or article may be used in place of a single device or article. Similarly, where more than one device or article is described herein, it will be clear that a single device or article may be used in place of the more than one device or article.

The functionality or the features of a device may be alternatively embodied by one or more other devices that are not explicitly described as having such functionality or features. Thus, other embodiments of one or more of the inventions need not include the device itself.

Techniques and mechanisms described or referenced herein will sometimes be described in singular form for clarity. However, it should be appreciated that particular embodiments may include multiple iterations of a technique or multiple instantiations of a mechanism unless noted otherwise. Process descriptions or blocks in figures should be understood as representing modules, segments, or portions of code which include one or more executable instructions for implementing specific logical functions or steps in the process. Alternate implementations are included within the scope of embodiments of the present invention in which, for example, functions may be executed out of order from that shown or discussed, including substantially concurrently or in reverse order, depending on the functionality involved, as would be understood by those having ordinary skill in the art.

Software/hardware hybrid implementations of at least some of the embodiments disclosed herein may be implemented on a programmable network-resident machine (which should be understood to include intermittently connected network-aware machines) selectively activated or reconfigured by a computer program stored in memory. Such network devices may have multiple network interfaces that may be configured or designed to utilize different types of network communication protocols. A general architecture for some of these machines may be described herein to illustrate one or more exemplary means by which a given unit of functionality may be implemented. According to specific embodiments, at least some of the features or functionalities of the various embodiments disclosed herein may be implemented on one or more general-purpose computers associated with one or more networks, such as for example an end-user computer system, a client computer, a network server or other server system, a mobile computing device (e.g., tablet computing device, mobile phone, smartphone, laptop, or other appropriate computing device), a consumer electronic device, a music player, or any other suitable electronic device, router, switch, or other suitable device, or any combination thereof. In at least some embodiments, at least some of the features or functionalities of the various embodiments disclosed herein may be implemented in one or more virtualized computing environments (e.g., network computing clouds, virtual machines hosted on one or more physical computing machines, or other appropriate virtual environments).

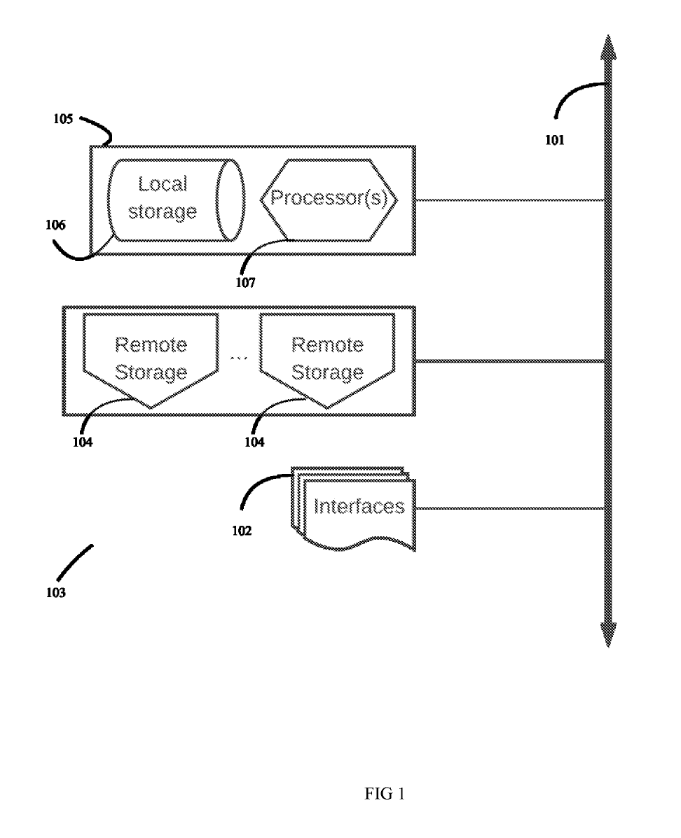

Referring now to FIG. 1, which shows a diagram view which shows an exemplary hardware architecture of a computing device used in an embodiment of the invention. The communications network 101 comprises a communications network that allows computers to exchange data using known protocols. In some embodiments, it is thought that examples of communications network 101 may include: personal area network, wireless personal area network, near-me area network, local area network, wireless local area network, wireless mesh network, wireless metropolitan area network, wireless wide area network, cellular network, home area network, storage area network, campus area network, backbone area network, metropolitan area network, wide area network, enterprise private network, virtual private network, intranet, extranet, Internetwork, Internet, near field communications, mobile telephone network, CDMA network, GSM cellular networks, or Wi-Fi network.

Interface 102 comprises a mechanism to control the sending and receiving of data packets over a computer network or support peripherals used with the computing device 103. In some embodiments, it is thought that examples of interface 102 may include: network interface cards (NICs), ethernet interfaces, frame relay interfaces, cable interfaces, DSL interfaces, token ring interfaces, graphics interfaces, universal serial bus (USB) interfaces, Serial port interfaces, Ethernet interfaces, FIREWIRE™ interfaces, THUNDERBOLT™ interfaces, PCI interfaces, parallel interfaces, radio frequency (RF) interfaces, BLUETOOTHTM interfaces, near-field communications interfaces, 802.11 (Wi-Fi) interfaces, frame relay interfaces, TCP/IP interfaces, ISDN interfaces, fast Ethernet interfaces, Gigabit Ethernet interfaces, Serial ATA (SATA) or external SATA (ESATA) interfaces, high-definition multimedia interface (HDMI), digital visual interface (DVI), analog or digital audio interfaces, asynchronous transfer mode (ATM) interfaces, high-speed serial interface (HSSI) interfaces, Point of Sale (POS) interfaces, or fiber data distributed interfaces (FDDIs).

Computing device 103 comprises an electronic device capable of executing software- or hardware-based instructions according to one or more programs stored in memory. In some embodiments, it is thought that examples of computing device 103 may include: desktop computers, carputers, game consoles, laptops, notebooks, palmtop, tablet, smartphones, smartbooks, or a server system utilizing CPU 105, local memory 106 and/or remote memory 104, and interface 102. Remote memory 104 comprises a service that provides users with a system for the backup, storage, and recovery of data.

CPU 105 comprises a unit responsible for implementing specific functions associated with the functions of specifically configured computing device or machine. The central processing unit is an acronym which stands for CPU 105. In some embodiments, it is thought that examples of CPU 105 may include: system-on-a-chip (SOC) type hardware, Qualcomm SNAPDRAGON™, or Samsung EXYNOS™ CPU. Local memory 106 comprises one or more physical devices used to store programs (sequences of instructions) or data (e g. program state information) on a temporary or permanent basis for use in a computer or other digital electronic device, which may be configured to couple to the system in many different configurations. In some embodiments, it is thought that examples of local memory 106 may include: non-volatile random-access memory (RAM), read-only memory (ROM), or one or more levels of cached memory. Local memory 106 functions to both 1) cache and/or store data and to 2) store programming instructions. In some embodiments, it is thought that examples of processor 107 may include: Intel processor, ARM processor, Qualcomm processor, AMD processor, application-specific integrated circuits (ASICs), electrically erasable programmable read-only memories (EEPROMs), field-programmable gate arrays (FPGAs), mobile processor, microprocessor, microcontroller, microcomputer, programmable logic controller, or programmable circuit.

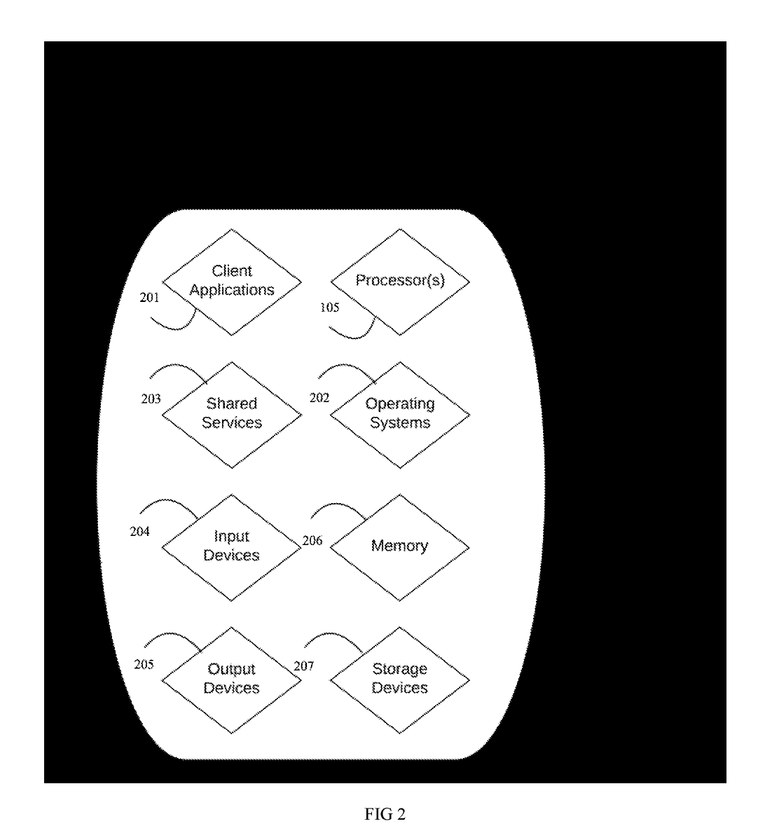

Referring now to FIG. 2, which shows a diagram view which shows an exemplary logical architecture for a client device, according to an embodiment of the invention.

Operating systems 202 comprises system software that manages computer hardware and software resources and provides common services for computer programs. In some embodiments, it is thought that examples of operating systems 202 may include: Microsoft's WINDOWS™, Apple's Mac OS/X, iOS operating systems, Linux operating system, or Google's ANDROID™ operating system.

Shared service 203 comprises web-enabled services or functionality related to a computing device 103.

Input devices 204 comprises device of any type suitable for receiving user input. In some embodiments, it is thought that examples of input devices 204 may include: keyboard, touchscreen, microphone, mouse, touchpad, or trackball. Output devices 205 comprises device of any type suitable for outputting computing device 103 related information. In some embodiments, it is thought that examples of output devices 205 may include: screens for visual output, speakers, or printers.

Memory 206 comprises mechanism designed to store program instructions, state information, and the like for performing various operations described herein, may be storage devices 207, in some embodiments. In some embodiments, it is thought that examples of memory 206 may include: read-only memory (ROM), read-only memory (ROM) devices, memristor memory, random access memory (RAM), or RAM hardware modules.

Storage devices 207 comprises mechanism designed to store information which in some embodiments may be memory 206. In some embodiments, it is thought that examples of storage devices 207 may include: magnetic media, hard disks, floppy disks, magnetic tape, optical media, CD-ROM disks, magneto-optical media, optical disks, flash memory, solid state drives (SSD), “hybrid SSD” storage drives, swappable flash memory modules, thumb drives, thumb drives, removable optical storage discs, or electrical storage device.

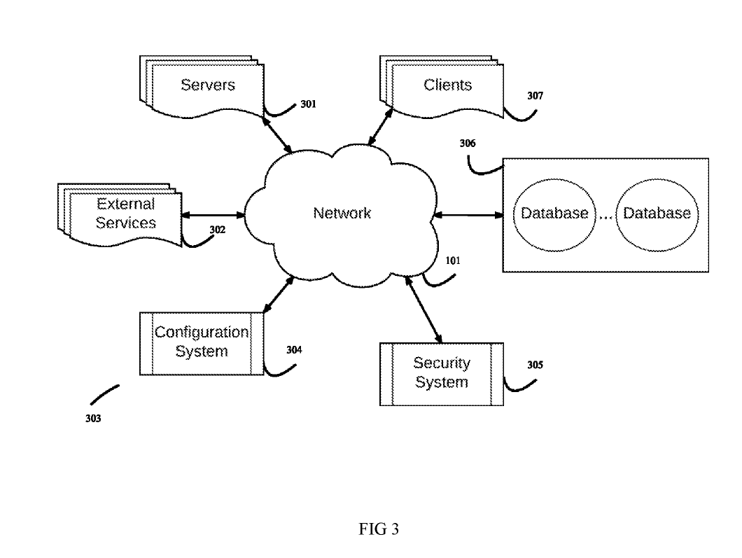

Referring now to FIG. 3, which shows a diagram of an exemplary architectural arrangement of clients, servers, and external services, according to an embodiment of the invention.

Server 301 comprises a computing device 103 configured to handle requests received from one or more client 307 over a communications network 101. External service 302 comprises web-enabled services or functionality related to or installed on a computing device 103 itself which may be deployed on one or more of an enterprise's or user's premises.

Distributed computing network 303 comprises any number of client 307 and/or server 301 operably connected to a communications network 101 for the purposes of implementing the system.

Configuration system 304 comprises a system common to information technology (IT) and web functions that implements configurations or management system.

Security system 305 comprises a system common to information technology (IT) and web functions that implements security related functions for the system.

Database 306 comprises an organized collection of data within an instruction related system, designed to allow the definition, creation, querying, update, and administration of databases. In some embodiments, it is thought that examples of database 306 may include: relational database system, NoSQL system, Hadoop system, Cassandra system, Google Bitable, column-oriented databases, in-memory databases, or clustered databases. Client 307 comprises one or more computing device 103 with program instructions for implementing client-side portions of the present system which in some embodiments, may be connected to a communications network 101.

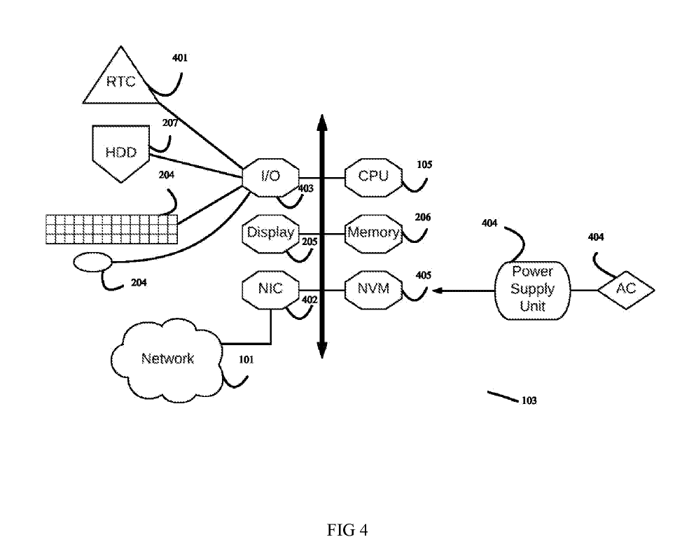

Referring now to FIG. 4, which shows a diagram view which shows an embodiment of a hardware architecture of a computing device used in various embodiments of the invention. Real time clock 401 comprises a computing device 103 clock (most often in the form of an integrated circuit) that keeps track of the current time.

Nic 402 comprises a computer hardware component that connects a computer to a computer network. Input output units 403 comprises devices used by a human (or other system) to communicate with a computer. Power supply 404 comprises an electronic device that supplies electric energy to an electrical load. Nonvolatile memory 405 comprises computer memory that can retrieve stored information even after having been power cycled (turned off and back on).

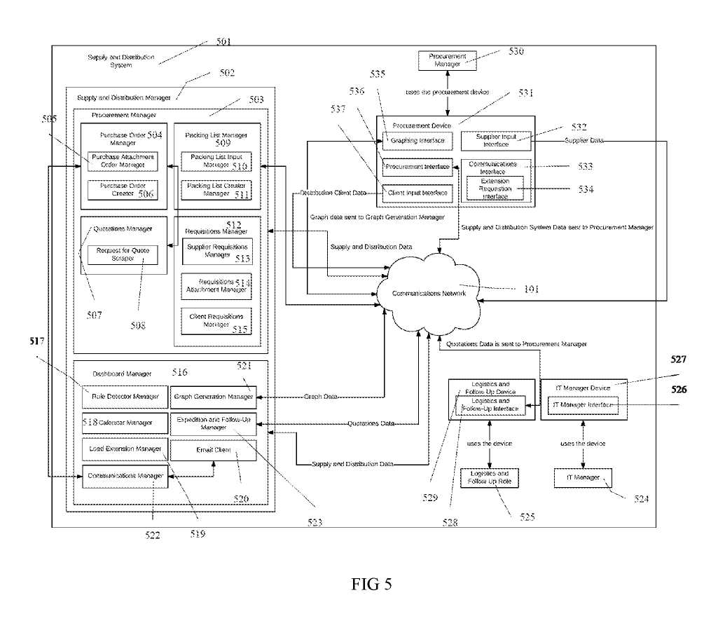

Referring now to FIG. 5, which shows an overall use of the system. Supply and distribution system 501 comprises a method and system which allows the interaction with one or more distribution client and one or more supplier. The Supply and distribution system 501 preferably comprises an it manager device 527, a logistics and follow up device 529, a procurement device 531, a supply and distribution system data 601, and finally a supply and distribution manager 502.

The Supply and distribution manager 502 is a module which sends, receives and processes supply and distribution system data 601 via a communications manager 522. The supply and distribution manager 502 comprises a procurement manager 503 and a dashboard manager 516.

The procurement manager 503 is a module which sends, receives and processes quotations data 612 via a communications network 101. The procurement manager 503 preferably comprises a purchase order manager 504, a packing list manager 509, a quotations manager 507, and finally a requisitions manager 512. The purchase order manager 504 is a module which sends and receives purchase order data 619 via a communications network 101. The purchase order manager 504 comprises a purchase order creator 506 and purchase order attachment manager 505. The purchase order attachment manager 505 is a module which sends and receives purchase order data 619 to the communications manager 522 and allows for the adding of additional external attachments (video files, pamphlets, etc.) to the purchase order data 619 for transmission via the communications manager 522. One purpose of the purchase order attachment manager 505 is to enable the procurement manager person 530 to add additional files or attachments to the communications data 609 that is created from the purchase order data 619.

The purchase order creator 506 is a module which creates either a supplier purchase order data 617 and/or a client purchase order data 618 and transmits it to the purchase order manager 504.

The quotations manager 507 sends and receives quotations data 612 via a communications network 101, in addition the quotations manager 507 compares and analyses quotations data 612 from one or more suppliers. The Quotations manager 507 functions to both 1) analyze the quotations data 612 from one or more suppliers to determine the best supplier quote data 616 and to 2) process the quotations data 612 that is received in the system and send it to communications manager 522 for transmission to a distribution client. The quotations manager 507 preferably comprises a request for quote scraper 508.

The request for quote scraper 508 is a module which generates client request for quote data 614 and or supplier request for quote data 615 from manual inputs, such as excel sheets, pdf files, word documents, OCR documents into the supply and distribution system 501. One purpose of the request for quote scraper 508 is to enable the supply and distribution system 501 to automatically generate client request for quote data 614 and supplier request for quote data 615 from letters and other non-computing data.

The packing list manager 509 is a module which sends and receives packing list data 602 via a communications network 101.

The packing list manager 509 comprises a packing list input manager 510 and a packing list creator manager 511. Packing list input manager 510 has a graphical user interface which allows for the manual input of packing list data 602. The packing list creator manager 511 is a module which creates a packing list, from the quotations data 612, for transmission via the communications manager 522.

The requisitions manager 512 is a module which sends and receives quotations data 612 via a communications network 101. The requisitions manager 512 preferably comprises a client requisitions manager 515, a supplier requisitions manager 513, and finally a requisitions attachment manager 514. The supplier requisitions manager 513 is a module that sends and receives supplier specific quotations data 612 to the communications manager 522 and processes the supplier specific quotations data 612.

The requisitions attachment manager 514 is a module which sends and receives quotations data 612 to the communications manager 522 and allows for the adding of additional external attachments (video files, pamphlets, etc.) to the quotations data 612 for transmission via the communications manager 522. One purpose of the requisitions attachment manager 514 is to enable the procurement manager person 530 to add additional outside information and attachments to the communications data 609 that is created from specific quotations data 612.

The client requisitions manager 515 sends and receives distribution client specific quotations data 612 to the communications manager 522 and processes the distribution client specific quotations data 612.

The dashboard manager 516 sends and receives communications data 609, graph data 603, supplier data 604, and distribution client data 605 via a communications network 101. The dashboard manager 516 preferably comprises an expediting and follow up manager 523, a graph generation manager 521, a load extension manager 519, a communications manager 522, an email client 520, a role detector manager 517, and finally a calendar manager 518.

The role detector manager 517 is a module which determines the role of the user of the supply and distribution system 501 and configures the system for use by that role. One goal of role detector manager 517 is to enable the supply and distribution system 501 to be configured for use by multiple differing users and role types.

The calendar manager 518 is a module which keeps track of and allows for the interaction and viewing of the delivery due dates of quotations data 612. One purpose of the calendar manager 518 is to enable the supply and distribution system 501 to track the due dates of quotations data 612 and display them in a calendar interface for tracking by users of the supply and distribution system 501.

The Load extension manager 519 is a module that sends, receives and displays communications data 609 via communications network 101. One purpose of the load extension manager 519 is to enable the procurement manager person 530 to edit, and send the extension letter 610 to a distribution client.

The email client 520 is a module which allows for the transmission of email messages via a communications network 101 with users outside of the supply and distribution system 501.

The graph generation manager 521 is a module which sends and receives graph data 603 via a communications network 101 and generates new graph data 603 based on the supply and distribution system data 601 stored in the supply and distribution system 501. One purpose of the graph generation manager 521 is to enable the supply and distribution system 501 to generate graphical representations of the supply and distribution system data 601.

The communications manager 522 is a module which sends and receives communications data 609 to one or more distribution client or one or more suppliers via the supply and distribution system 501.

The expediting and follow up manager 523 is a module which sends and receives quotations data 612 and processes the quotations data 612 to determine if further follow-up is needed to complete the order. One purpose of the expediting and follow up manager 523 is to enable the supply and distribution system 501 to determine if any instances of quotations data 612 require further follow-up or if further communication needs to be sent to one or more suppliers or one or more distribution clients regarding the instance of quotations data 612.

IT manager 524 is responsible for implementing and maintaining an organization's technology infrastructure.

Logistics and follow up role 525 is the person who is responsible for managing the outstanding orders within the company.

The It manager interface 526 comprises graphical user interface configured for use by an it manager 524. The It manager device 527 is a computing device 103 which allows an it manager 524 to engage with the supply and distribution system 501. In some embodiments, it is thought that if it manager device 527 is absent then the it manager 524 can access the supply and distribution system 501 via a non-specific computing device 103. The it manager device 527 preferably comprises it manager interface 526.

The logistics and follow up interface 528 comprises a graphical user interface configured for use by a logistics and follow up role 525. Logistics and follow up device 529 is a computing device 103 which allows a logistics and follow up role 525 to interact with the supply and distribution system 501. Logistics and follow up device 529 preferably comprises a logistics and follow up interface 528.

The procurement manager person 530 is an employee within a company, business or other organization who is responsible at some level for buying or approving the acquisition of goods and services needed by the company. The procurement device 531 is a device configured for use by a procurement manager person 530. The procurement device 531 preferably comprises a procurement interface 536, a graphing interface 535, a client input interface 537, a communications interface 533, and finally a supplier input interface 532.

The Supplier input interface 532 is a graphical user interface which permits the input of supplier data 604. One goal of supplier input interface 532 is to enable the input of supplier data 604 into the supply and distribution system 501.

The communications interface 533 is a graphical user interface which allows for the input and viewing of communications data 609 in the supply and distribution system 501. The communications interface 533 preferably comprises an extension requisition interface 534.

The extension requisition interface 534 is a graphical user interface which allows for the input of communications data 609 for the creation of an extension letter 610.

The graphing interface 535 is a graphical user interface which displays graph data 603 received from the graph generation manager 521 via a communications network 101.

The procurement interface 536 is a graphical user interface which allows for the interaction with the procurement device 531 and allows for the sending and receiving of supply and distribution system data 601 via a communications network 101. One purpose of the procurement interface 536 is to enable the procurement manager person 530 to interact with the supply and distribution system 501 and the supply and distribution system data 601. The procurement interface 536 preferably comprises a purchase order interface 706, a quotations interface 701, a requisitions interface 707, a markup module interface 709, a load extension interface 708, and finally an expediting and follow-up interface 705.

The client input interface 537 is a graphical user interface which allows for the input of distribution client data 605. One purpose of the client input interface 537 is to enable the input of distribution client data 605 into the supply and distribution system 501.

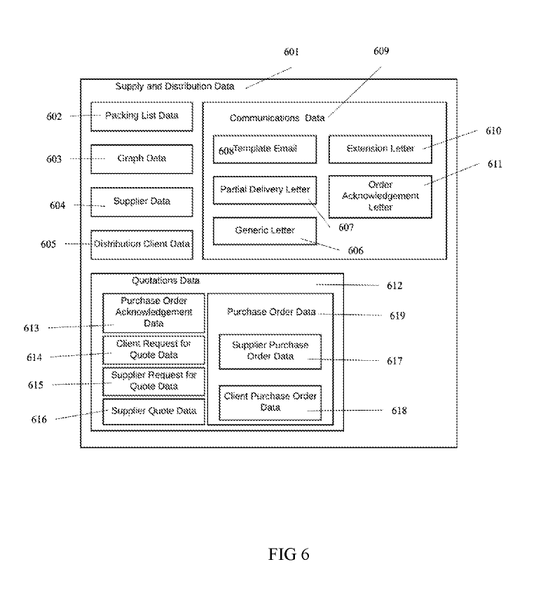

Referring now to FIG. 6, which shows System Data.

Supply and distribution system data 601 is a data or data object which stores information for use in the supply and distribution system 501. Supply and distribution system data 601 preferably comprises distribution client data 605, quotations data 612, packing list data 602, graph data 603, communications data 609, and finally supplier data 604.

Packing list data 602 is a data or data object which stores information regarding items which are to be sent to a distribution client in accordance with a client purchase order data 618. In some embodiments, it is thought that examples of packing list data 602 may include: delivery terms, customs documents for international shipments, or shipping terms.

Graph data 603 is data or data object which stores information about graphs or other visual representations of the supply and distribution system data 601.

Supplier data 604 is a data or data object which stores information regarding one or more suppliers. In some embodiments, it is thought that examples of supplier data 604 may include: client, website, or email.

Distribution client data 605 is a data or data objet which stores information regarding a distribution client. In some embodiments, it is thought that examples of distribution client data 605 may include: email, person of contact, or web site.

Generic letter 606 comprises a letter template which can have additional content manually added for transmission to a distribution client.

Partial delivery letter 607 comprises a letter that is sent to distribution client indicating that the delivered order is a partial delivery of an order and the remaining items will be delivered later.

Template email 608 comprises a data or data object which stores information regarding a template email which can have data added to it, such as quotations data 612 by the supply and distribution system 501 for sending to either a distribution client or a supplier via the email client 520.

Communications data 609 is a data or data object which stores communication information which can be sent by the supply and distribution system 501. Communications data 609 preferably comprises an extension letter 610, an order acknowledgement letter 611, a template email 608, a partial delivery letter 607, and finally a generic letter 606.

The extension letter 610 comprises a letter template which can be sent by the email client 520 to a client 307. In some embodiments, it is thought that examples of extension letter 610 may include: requesting the extension of the quote due date, asking for an extension of the delivery date, or asking for an extension of the delivery time.

Order acknowledgement letter 611 is a data or data object which stores information regarding the order acknowledgement that can be sent to the client 307.

Quotations data 612 is a data or data object which stores information in the supply and distribution system 501 regarding quotations and request for quotations to distribution client and supplier regarding items which can be supplied. Quotations data 612 preferably comprises supplier quote data 616, supplier request for quote data 615, client request for quote data 614, purchase order acknowledgement data 613, and finally purchase order data 619.

Purchase order acknowledgement data 613 comprises data or data object which stores information regarding the receipt and acceptance of one or more client purchase order data 618.

Client request for quote data 614 comprises data or data object which stores information regarding a request for quote from a distribution client. In some embodiments, it is thought that examples of client request for quote data 614 may include: bid time due date, bidding process, client, place, person of contact, bidding process type, import item (excel, pdf, manual input), fry number, bid due date, system reference data, delivery date, delivery terms, category (type of material), client contact phone number, comments, extraneous information, extraneous charges, or shipping costs.

Supplier request for quote data 615 comprises data or data object which stores information regarding a request for quote that is to be sent to supplier.

Supplier quote data 616 comprises data or data object which stores information regarding items that a supplier can supply in response to a supplier request for quote data 615.

Supplier purchase order data 617 comprises data or data object which stores information regarding the items to be supplied by a supplier in response to a supplier quote data 616. In some embodiments, it is thought that examples of supplier purchase order data 617 may include: fry number, bidding process, client, place, person of contact, bidding process type, import item (excel, pdf, manual input), bid due date, system reference data, bid time due date, delivery terms, delivery date, category (type of material), client contact phone number, or comment.

Client purchase order data 618 comprises data or data object which stores information regarding the items which can be supplied to a distribution client in response to a client request for quote data 614. In some embodiments, it is thought that examples of client purchase order data 618 may include: RFK number, bidding process, client, place, person of contact, bidding process type, import item (excel, pdf, manual input), bid due date, system reference data, bid time due date, delivery date, delivery terms, category (type of material), client contact phone number, or comment.

Purchase order data 619 comprises data or data object which stores information about a purchase order. Purchase order data 619 comprises supplier purchase order data 617 and client purchase order data 618.

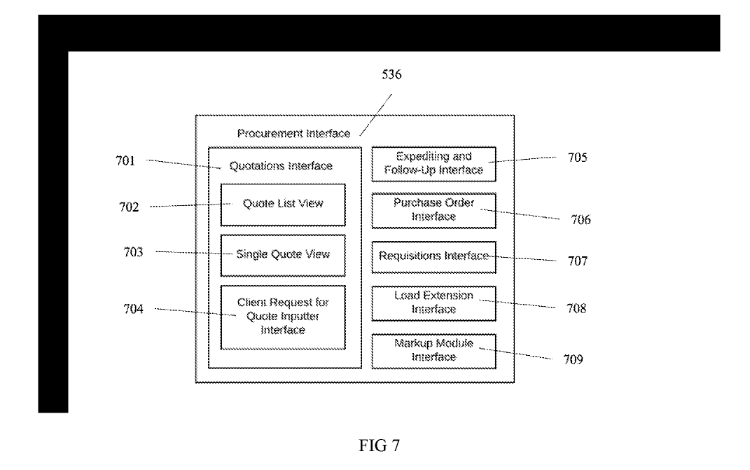

Referring now to FIG. 7, which shows Procurement Interface.

Quotations interface 701 is a graphical user interface for sending and receiving quotations data 612 to the quotations manager 507 via a communications network 101. Quotations interface 701 preferably comprises a single quote view 703, a quote list view 702, and finally a client request for quote inputter interface 704.

Quote list view 702 is a graphical user interface which displays information about all instances of quotations data 612 stored in the supply and distribution system 501. One goal of the quote list view 702 is to enable the procurement device 531 to show a list of all pieces of quotations data 612 that have been input into the supply and distribution system 501.

Single quote view 703 is a graphical user interface which displays information about a unique instance of quotations data 612. One purpose of the single quote view 703 is to enable the supply and distribution system 501 to show and provide information regarding a unique instance of quotations data 612 as it is stored within the supply and distribution system 501.

Client request for quote inputter interface 704 is a graphical user interface which allows for the input of client request for quote data 614 for transmission via a communications network 101.

The Expediting and follow-up interface 705 is a graphical user interface which sends and receives communications data 609 and quotations data 612 via the communications manager 522 and email client 520. One goal of expediting and follow-up interface 705 is to enable the procurement manager person 530 to send and receive communications data 609 to one or more distribution client and one or more supplier.

The Purchase order interface 706 is a graphical user interface which sends and receives purchase order data 619 to the purchase order manager 504 via a communications network 101. The requisitions interface 707 is a graphical user interface which talks to the requisitions manager 512 to send and receive quotations data via a communications network 101.

The load extension interface 708 is a graphical user interface which sends, receives, and displays communications data 609 from the load extension manager 519. One goal of load extension interface 708 is to enable the procurement manager person 530 to process and send communications data 609 including extension letter 610 to one or more supplier.

The markup module interface 709 is a graphical user interface which allows a procurement manager person 530 to apply a markup to one or more supplier quote data 616 which are then sent to the purchase order manager 504. One goal of markup module interface 709 is to enable a procurement manager person 530 to input a markup cost into the supply and distribution system 501 for the generation of a client purchase order data 618.

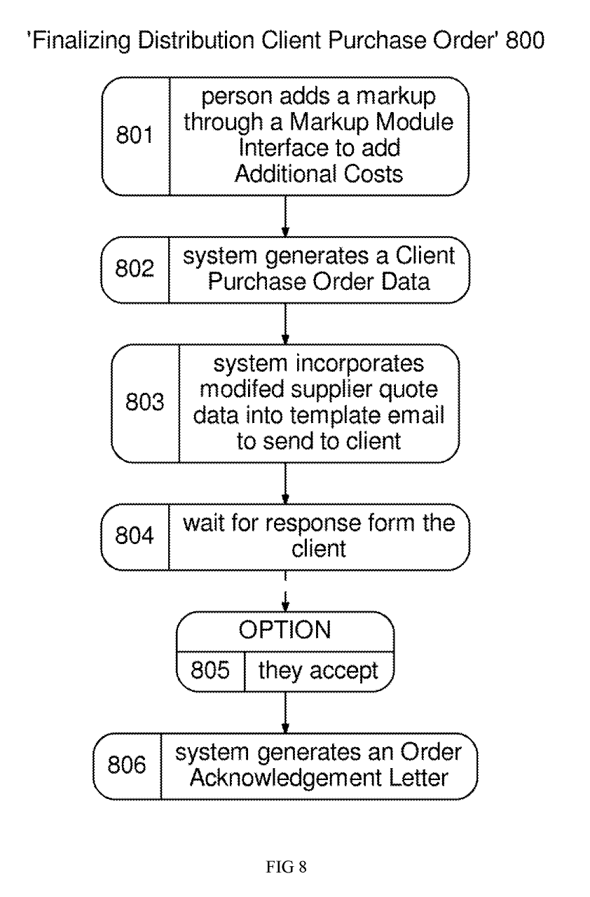

Referring now to FIG. 8, which shows finalizing distribution client purchase order.

In a first step, person adds a markup through a markup module interface 709 to add additional costs (Step 801). Next, system generates a client purchase order data 618 (Step 802). Next, system incorporates modified supplier quote data into template email to send to client (Step 803). Next, wait for response form the client (Step 804). If they accept (Step 805), then system generates an order acknowledgement letter 611 (Step 806).

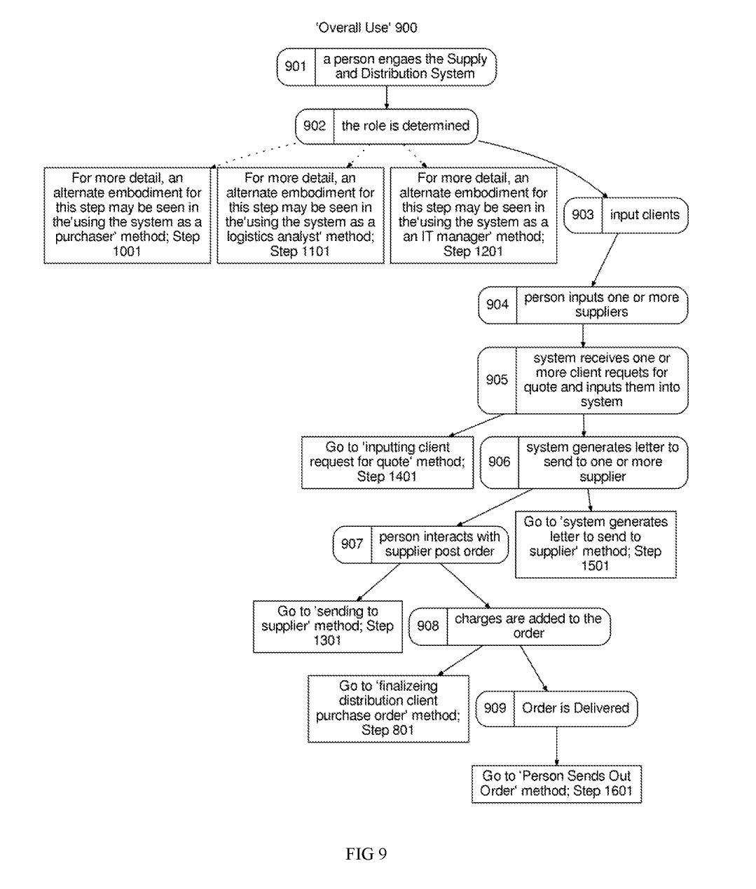

Referring now to FIG. 9, which shows the overall use.

In a first step, a person engages the supply and distribution system 501 (Step 901). Next, the role is determined (Step 902). In an alternative embodiment, Step 902 may be performed as in Method (1000—‘using the system as a purchaser’). Next, input clients (Step 903). Next, person inputs one or more suppliers (Step 904). Next, system receives one or more client requests for quote and inputs them into system (Step 905). Step 905 is further detailed below in a related method (1400—‘inputting client request for quote’). Next, system generates letter to send to one or more supplier (Step 906). Step 906 is further detailed below in a related method (1500—‘system generates letter to send to supplier’). Next, person interacts with supplier post order (Step 907). Step 907 is further detailed below in a related method (1300—‘sending to supplier’). Next, charges are added to the order (Step 908). Step 908 is further detailed below in a related method (800—‘finalizing distribution client purchase order’). Next, Order is Delivered (Step 909). Step 909 is further detailed below in a related method (1600—‘Person Sends Out Order’).

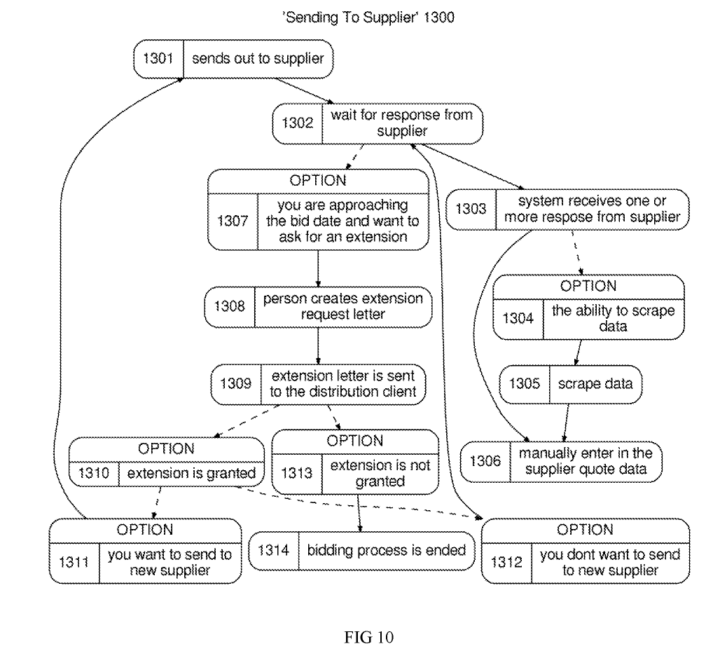

Referring now to FIG. 10, which shows using the system as a purchaser.

In a first step, system designates the role as the purchaser (Step 1001). If the person wants to examine if they have a purchase order (Step 1002), then person can examine calendar or pup notifications (Step 1003). From Step 1001, if person wants to examine the data and logistics (Step 1004),

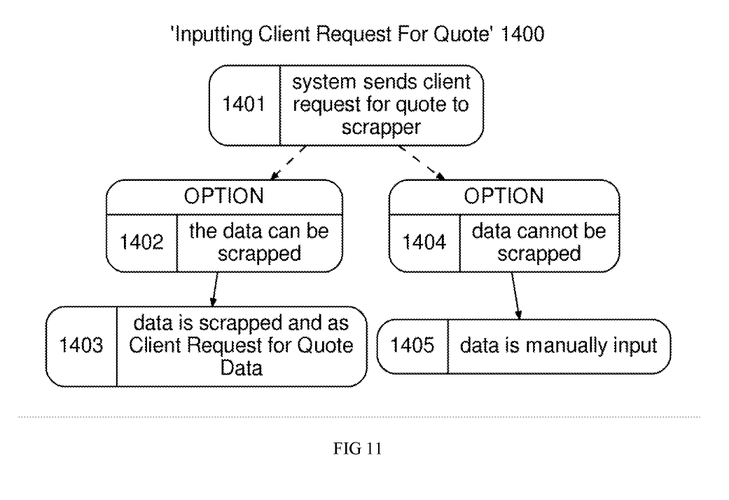

Referring now to FIG. 11, which shows using the system as a logistics analyst.

In a first step, showing logistics analyst modules in non-editable view (Step 1101).

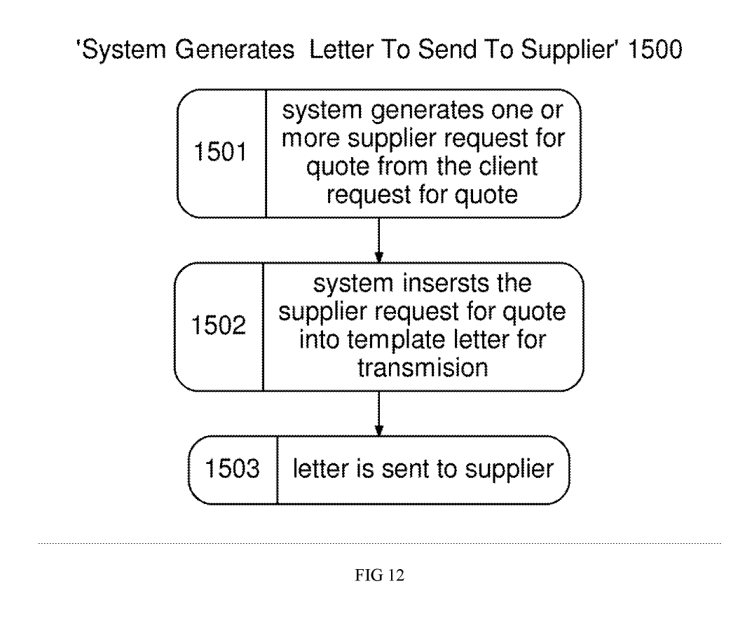

Referring now to FIG. 12, which shows using the system as an IT manager.

In a first step, customizable view is visible (Step 1201).

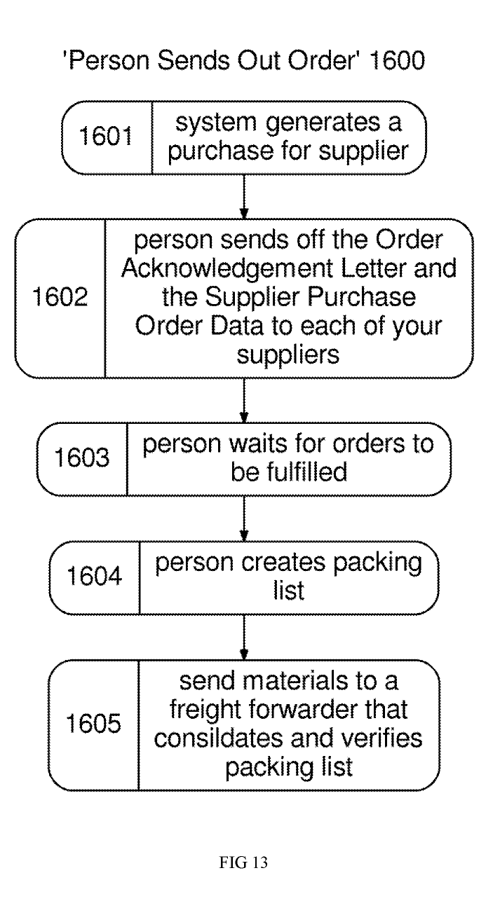

Referring now to FIG. 13, which shows sending to supplier.

In a first step, sends out to supplier (Step 1301). Next, wait for response from supplier (Step 1302). Next, system receives one or more response from supplier (Step 1303). If the ability to scrape data (Step 1304), then scrape data (Step 1305). Next, manually enter in the supplier quote data (Step 1306). From Step 1303, next, refer to Step 1306. From Step 1302, if you are approaching the bid date and want to ask for an extension (Step 1307), then person creates extension request letter (Step 1308). Next, extension letter is sent to the distribution client (Step 1309). If extension is granted (Step 1310), and if you want to send to new supplier (Step 1311). then refer to Step 1301. From Step 1310, if you don't want to send to new supplier (Step 1312), then refer to Step 1302. From Step 1309, if extension is not granted (Step 1313), then bidding process is ended (Step 1314).

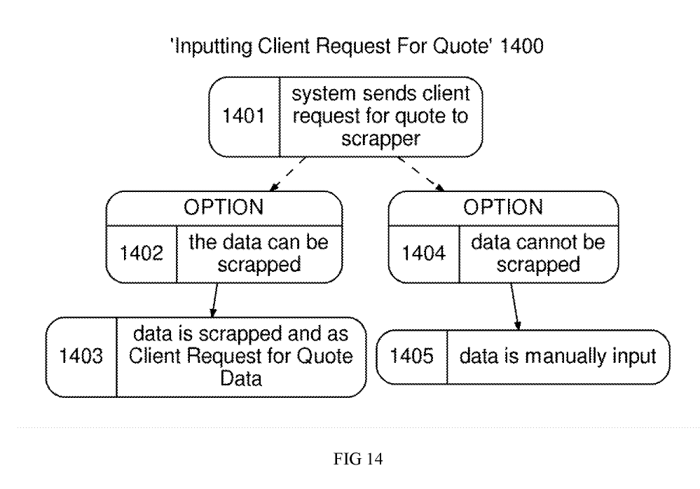

Referring now to FIG. 14, which shows inputting client request for quote.

In a first step, system sends client request for quote to scrapper (Step 1401). If the data can be scrapped (Step 1402), then data is scrapped and as client request for quote data 614 (Step 1403). From Step 1401, if data cannot be scrapped (Step 1404), then data is manually input (Step 1405).

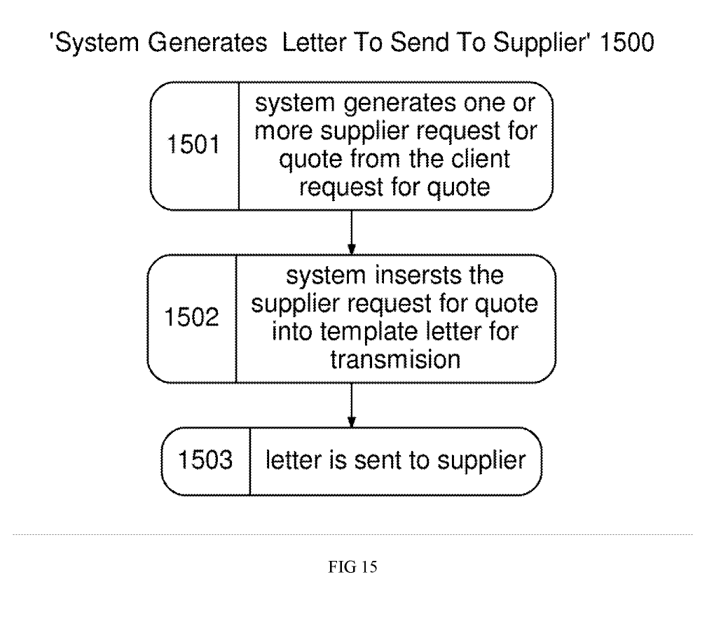

Referring now to FIG. 15, which shows system generates letter to send to supplier.

In a first step, system generates one or more supplier request for quote from the client request for quote (Step 1501). Next, system inserts the supplier request for quote into template letter for transmission (Step 1502). Next, letter is sent to supplier (Step 1503).

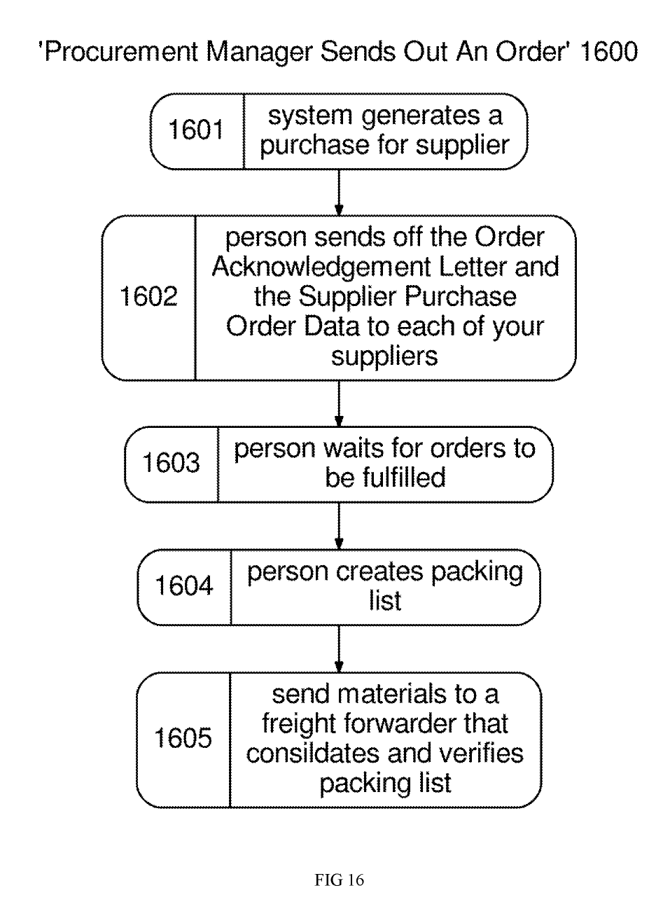

Referring now to FIG. 16, which shows Person Sends Out Order.

In a first step, system generates a purchase for supplier (Step 1601). Next, person sends off the order acknowledgement letter 611 and the supplier purchase order data 617 to each of your suppliers (Step 1602). Next, person waits for orders to be fulfilled (Step 1603). Next, person creates packing list (Step 1604). Next, send materials to a freight forwarder that consolidates and verifies packing list (Step 1605).

The following elements and/or terms physical ports, independent processor, interface memory, busses, program instructions, system server, system, supplier, distribution client, graphical user interface, purchase order and additional costs are important for the working functionality, but do not appear in the drawings and are shown below.

In some embodiments, it is thought that an example of independent processor could be audio processor or perhaps video processor and the like.

In some embodiments, it is thought that an example of interface memory may include volatile and/or non-volatile memory (e.g., RAM) and the like.

Busses comprises a communication system that transfers data between components inside a computer, or between computers.

Program instructions comprises a mechanism for control execution of, or comprise of an operating system, and/or one or more applications. In some embodiments, it is thought that examples of program instructions may include: object code, code produced by a compiler, machine code, code produced by an assembler or a linker, byte code, or code executed using an interpreter.

System server comprises a computing device 103. Supplier comprises a person or corporation who can fulfill a supplier request for quote data 615. Distribution client comprises a company or person who submits a client request for quote data 614 into the supply and distribution system 501.

Graphical user interface comprises a visual way of interacting with a computing device 103 using items such as windows, icons, and menus, used by most modern operating systems.

Purchase order comprises A purchase order (PO) is a commercial document and first official offer issued by a buyer to a seller, indicating types, quantities, and agreed prices for products or services. It is used to control the purchasing of products and services from external suppliers.

Additional costs are costs which are above and beyond the direct procurement costs of the item.

### EXAMPLE

Below is an example of how the embodiments of the invention can be used. The example is not meant to be limiting in any manner.

### Inputting Client's Request for Quote

This module registers and saves the requests for quotes, these requests contain client information, delivery terms, type of material, quantity requested, number of items, brief item description, and additional variable. There are two ways of loading information into the module, one is by manual input, and the other is by using an Excel sheet.

1—Manual Input: Data registered manually ranges from client information, to item descriptions. In this embodiment, the system saves the information input for each item, it indicates to the user automatically which item it's on.

2—Excel Sheet: Client information is input manually into the system. However, the specific item information is loaded via an interface, which loads the information very quickly and automatically. This option is often utilized when the request for quote contains many items.

When each item is being registered and saved, this information is easily accessible and editable if any mistakes are found in the information loading process. The things editable include but are not limited to the item description, units, quantity, and additional variables. This editing also allows for the elimination of complete items. Additionally, this module allows you to recover requests with information which was saved partially, with the purpose of finishing these requests for quotes, and proceeding to the next module.

This System handles all possible entry validations with the purpose of evading data duplication or incorrect information. In the data entry system, the user can register new clients, types of materials, and any data regarding the statistical table of the database through emerging windows.

### Request for Quote Number

The system can automatically generate a quote numbering system, for internal use and control for the rest of the process. This number is generated by the Year-Month and one consecutive number per month, which resets to 001 at the end of each month, for example:
2017-02-003: Which indicates this is the third request for the month of February 2017.
2017-03-003: Which indicates this is the third request for the month of March 2017.
2017-04-001: Which indicates this is the first request for the month of April 2017.

### Information Updates to Request for Quote Module

In this module, the information on previously registered RFQ's can be edited or updated. Before entering the module, a search is performed for the request the user would like to update, once found, any changes are made by clicking the update button.

### Supplier Request for Quote Module

Once the client's RFQ has been loaded, the user can proceed to assign each item to individual suppliers from our database. Prior to the supplier assignment, the user can search for the specific request, and then continue to assign suppliers per item.

This item assignment is ruled by the suppliers, in other words, the user can select a group of items, and assign them to a group of suppliers directly, as well as choosing one item and assigning it to a group of suppliers. After the items have been selected and assigned to a group of suppliers, the user can move on to storing the information, and emailing the request for quote out to the supplier. This request can be a report in a .PDF format.

Once the RFQ has been sent by email, the system gives a Request Summary, which shows which suppliers were sent the Request, which were not, and which items were assigned to each supplier. The emails can be generated and sent internally through the system, via a SMTP protocol for the email delivery.

### Information Updates to Supplier's Request for Quote

In this module, the user can reassign items to suppliers, eliminate certain item assignments to certain suppliers, and send the RFQ emails to suppliers. The reassignment of items to suppliers includes adding or removing items to certain supplier's orders. Eliminating a supplier means this supplier is no longer going to quote those items originally assigned. The system is flexible in allowing the RFQ to be sent to the supplier via email in this module.

### Quoting Module

In this module, the user can proceed to register the prices which were requested from our suppliers. Prior to loading this information, the user can select which supplier will have these prices registered.

Once the supplier is selected, the user can also load the requested material provenance, payment terms, delivery terms, delivery location, transportation fees, tax, and additional variables. The prices are loaded in two ways, manual input, or through the Excel Sheet.

Manual Input: With this method, the user must go item by item inputting each price, payment terms, delivery terms, and additional variables. This is more commonly used when the quote has very few items.

Excel Sheet: When the user works with this method, the system generates a form with the supplier information, and assigned items to supplier which can load prices very quickly and automatically. This is more commonly applied when the quote has many items

The system can be particular in the way it stores information, for example, when there are repeating items, it saves the price in one of the items, and automatically updates the prices of the alike items. This particularity applies to both the manual input, and the excel sheet method.

The system also allows the user to view a pricing report, based on past prices quoted for that item with each supplier. After the prices have been loaded, the user can move on to completing the client's quote.

### Quote to Client

This module builds the quote that is sent to the client. This quote can be built in at least two ways, the first is to allow the system to select the suppliers based on superior pricing and delivery terms. The other way is to allow the user to choose the suppliers manually based on the user's criteria, and their knowledge of procurement and logistics. When choosing to pick suppliers manually, the user must enter a brief explanation as to why that supplier was chosen.

Once the selection of items and their pricing has been made, the user can proceed to load the delivery terms, payment terms, delivery location, shipping fees, and profit margin, which is applicable in percent form, or in absolute value. After saving the quote, the user can then send the quote via email for example, in a .PDF format.

### Excuse Letter

This module allows for the excuse letter to be sent to the client, if the user cannot fulfill the client's conditions, or their quote requirements.

### Client's Purchase Order Module

This is the module where Client's purchase orders are loaded to the system. Once received data has been received (payment terms, delivery terms, delivery location, time of delivery, and items awarded in this order) the rest of the data is taken from the RFQ.

After the information has been loaded, the awarded items are selected manually. If all items on the quote are awarded, the system gives the options to select ‘All Items’ at once. At the same time, the awarded items are being selected, the system registers the totals of costs, profit margins, gross percentage, and additional variables. Once the awarded items have been selected and approved, the system saves the purchase order.

When the purchase order has been registered and saved, the system checks it and compares it to the RFQ; If any discrepancy is found (errors in payment terms, delivery terms, price, and additional variables, the system will indicate an acknowledgement letter must be formulated automatically. This can delineate precisely where the information discrepancy is and then update the information to the client.

### Supplier's Purchase Order Module

This module is where the supplier's PO is loaded. Once the client PO is loaded, this is chosen to fill the supplier PO. While this information is being loaded, the user simultaneously loads delivery terms, delivery date, and certain documents that are needed to receive the material. Once all that has been loaded, the user begins choosing the items awarded to each supplier.

The system also has the option of placing discounts on prices which the supplier grants. It allows the user to add fees like shipping costs, or any documentation that the material requires as well as and any other cost generated by the supplier.

This module can be flexible when it comes to assigning items to different suppliers, as it allows for very easy selection of what items are awarded to each supplier. It also allows the user to assign different items to suppliers that had quoted previously and lost the bid, or to suppliers that are new to the system.

This module also allows partial delivery of purchase orders based on the quantity of the items. For example, if the user is awarded 10 pieces of a certain item, and the supplier may only have 4 pieces in stock, the system allows the user to assign 4 pieces to that supplier, and the rest of the order to another supplier. Once the purchase order had been loaded, the system can send an email to the supplier containing the purchase order for example, in a .PDF format.

### Follow Up/Logistics Module

This is the module where all follow up is done for an order from the moment it is requested from the supplier, to the final delivery and receipt from the end user. In this embodiment, the user has a note window, where all new events and actions to take for certain orders are registered. For example:
Aug. 12, 2017—PO was sent to the supplier, and the next action is to wait for the material to be sent from supplier.
Aug. 20, 2017—Supplier received PO, and the next action is to generate packing list in system.
Aug. 21, 2017—Packing list has been generated, and the next action is to generate an invoice for the client.

This information is collected, and can generate a history for each order, which presents itself in the initial system screen of each user, highlighting with alarms the actions to take.

### Packing List Module

This is the module where the user develops the packing list, by searching for the purchase order, and selecting it to fill the packing list sheet. In this packing list, the user must include dimensions of packed material ready to ship, delivery terms, and additional variables. These packing lists allow for partial deliveries, meaning, the system creates the packing lists for the awarded items, and another packing lists for the rest of the items awarded to another supplier.

Once the packing list has been generated, for example, in a PDF format, the system can generate and send a notification email to the finance department for them to generate an invoice that matches that packing list. After the invoice has been received, the user can proceed to send the packing list and invoice to the client through the system.

### Access and Roles in the System

The system manages the different roles by user, for example, one user with a ‘Buyer’ role, and another user with a ‘Manager’ role. When the user first enters the system, the system initially validates the user's access, and at the same time the system builds a drop-down menu with the options specifically related to the registered role of the user. In one embodiment, there is a menu with dynamic options, which are displayed depending on the role in which the user is registered.

Access to the system can be by means of username and password, which varies by user. Access can also be validated by using the company's Active Directory, if it applies.

### System Advantageous

The system can be entirely auditable, meaning, it allows the admin to see every entry by each individual user, logged and stored in the system's Edit Log Database. The system can allow the user to store documents and attachments referent to each process, stored in every loading module; which means, brochures, product photos, and additional specifications can be added to each loading module. For example, Client's RFQ Module, Supplier's RFQ Module, Supplier's Quote, Client's PO, Supplier's PO, Excuse Letter, and additional variables can be added. Furthermore, the user can store this information in each module. The system allows the user to do a general search to find this additional information that was previously stored.

The system presents an integrated design for email delivery, which automatically generates and delivers content when that is needed; this applies to send the RFQ to the Supplier, Sending Quote to the Client, Excuse Letter, Order Acknowledgment, and PO to the Supplier. With this option, the user avoids having to leave the system to generate an email, and attach the documents.

The System contains floating windows, which allows the user to load and register information regarding things like, registration of new suppliers, new clients, contact information, material categories, and additional variables. This can be done by users who have previously been granted access by the admin, without having to leave the current screen, and go to an Admin Module. As information is stored, the system can register and log all this information in the database.

The system can contain Excel forms, which allow the user to load massive amounts of information, very quickly and automatically, while the user loads the Client's RFQ, and the prices from the Supplier. The system can run a user-friendly interface, which is not only easy to use, but it becomes very familiar for most employees, and can be easily adaptable to most businesses who buy and sell material.

### Reports and Consulting Module

In this module, the user can observe information that refers to the process, consult pricing, review obtained earnings in each process, and additional variables. The reports generated are very detailed, and they allow the user to see in real time the information needed for every part of the process. These graphs can be generated and exported to a .PDF file, for example.

### System Architecture

The system has been developed in Visual Studio .NET and SQL Server used for database management. The architecture implemented was of N-Layers, for this case it was 3 layers.

One layer is the database, where all information sheets and reports are stored. The second layer is Store Procedure and function, which connects with the business layer are the WebServices, and this is the layer that connects to the .aspx pages. There can also be the presentation layer, which is where the user interacts.

### Calendar and Alerts

The system can contain a calendar and alerts module to notify the user of what RFQ's require attention soon, and which need to be sent to the supplier and to the client. Additionally, the system presents a calendar in the home screen to alert the user which activities are due that day or the following day. For example, any actions due for any order.

We claim:

1. A system comprising:
a. a communications network comprising computers to exchange data using protocols;
b. an interface comprising a mechanism to control the sending and receiving of data packets over the communications network;
c. a server configured to handle requests received from one or more client over the communications network;
d. a supply and distribution manager for sending, receiving and processing supply and distribution data via the communication network therein the supply and distribution manager comprises a procurement manager, a dashboard manager, wherein the procurement manager is a module which sends, receives and processes quotations data via the communications network, and wherein the purchase order manager is a module which sends and receives purchase order data via the communications network

2. The system of claim 1, wherein the procurement manager further comprises a purchase order manager, a packing list manager, a quotations manager, and a requisitions manager.

3. The system of claim 1, wherein the communication network further comprises an element selected from the group consisting of personal area network, wireless personal area network, near-me area network, local area network, wireless local area network, wireless mesh network, wireless metropolitan area network, wireless wide area network, cellular network, home area network, storage area network, campus area network, backbone area network, metropolitan area network, wide area network, enterprise private network, virtual private network, intranet, extranet, Internetwork, Internet, near field communications, mobile telephone network, CDMA network, GSM cellular networks, Wi-Fi network, and any combination thereof

4. The system of claim 3, wherein the purchase order manager comprises a purchase order creator and purchase order attachment manager.

5. The system of claim 4, wherein the purchase order attachment manager is a module which sends and receives purchase order data to the communications manager and allows for the adding of additional external attachments to the purchase order data for transmission via the communications manager.

6. The system of claim 5, wherein the quotations manager sends and receives quotations data via the communications network and the quotations manager compares and analyses quotations data from one or more suppliers.

7. The system of claim 6, wherein the quotations manager further comprises a request for quote scraper.

8. The system of claim 2, wherein the client requisitions manager sends and receives distribution client specific quotations data to the communications manager and processes the distribution client specific quotations data.

9. The system of claim 1, wherein the dashboard manager sends and receives communications data, graph data, supplier data, and the distribution client data via the communications network.

10. The system of claim 9, wherein the dashboard manager further comprises an expediting and follow up manager, a graph generation manage, a load extension manager, a communications manager, an email client, a role detector manager, and finally a calendar manager.

11. The system of claim 6 further comprising a purchase order creator, wherein the purchase order creator is a module which creates a supplier purchase order data or a client purchase order data and transmits it to the purchase order manager.

12. The system of claim 11, further comprising a quotations manager for sending and receiving quotations data via the communications network, wherein the quotations manager compares and analyzes quotations data from one or more suppliers.

13. A method comprising;
a. engaging a supply and distribution system;
b. determining a role for the supply and distribution system;
c. inputting the client into the supply and distribution system;
d. inputting at least one supplier into the supply and distributions system;
e. receiving at least one client request for quote and inputting the at least one client request for quote into the supply and distribution system;
f. generating a letter to send to the at least one supplier;
h. delivering order.

14. The method of claim 13, further comprising the step of using the supply and distribution system as a purchaser.

15. The method of claim 13, further comprising the step of using the supply and distribution system as a logistics analyst.

16. The method of claim 13, further comprising the step of using the supply and distribution system as an IT manager.

17. The method of claim 13, further comprising automatically generating a quote numbering system, for internal use and control.

18. The method of claim 13, further comprising assigning each item from the client request to at least one supplier in a database.

19. The method of claim 13, further comprising providing a request summary, which shows which suppliers were sent requests, which were not, and which items were assigned to the supplier.

20. The method of claim 13, further comprising providing a pricing report, based on past prices quoted for any item with the supplier.
